(19) United States
(12) Patent Application Publication
(10) Pub. No.: US 2026/0181332 A1
(43) Pub. Date: Jun. 25, 2026

(54) LOUDSPEAKER ASSEMBLY

(71) Applicant: Harman International Industries, Incorporated, Stamford, CT (US)

(72) Inventors: Jinquan Huang, Shenzhen (CN); Zhenjin Zhu, Shenzhen (CN); Jihui Zeng, Shenzhen (CN); Yadi Wang, Shenzhen (CN)

(73) Assignee: Harman International Industries, Incorporated, Stamford, CT (US)

(21) Appl. No.: 19/428,251

(22) Filed: Dec. 21, 2025

(30) Foreign Application Priority Data
Dec. 24, 2024 (CN) 202411918032.X

(51) Int. Cl. H04R 9/02; H04R 7/06; H04R 9/04; H04R 9/06

(52) U.S. Cl. CPC H04R 9/025; H04R 7/06; H04R 9/045; H04R 9/06

(57) ABSTRACT

A loudspeaker assembly having a magnetic circuit unit having a top plate and defining a magnetic gap. A frame unit is connected to the magnetic circuit unit. A vibration unit is connected to the frame unit and has an upper diaphragm, a voice coil, and a dome. The voice coil extends at least partially into the magnetic gap, wherein the dome comprises a dome main body and at least two crimped edge portions surrounding the dome main body, wherein the dome is affixed to a top side of the voice coil by means of the crimped edge portions, such that the top plate of the magnetic circuit unit is disposed in a middle of the voice coil in a height direction (z).

### CROSS REFERENCE

Priority is claimed to application serial no. 202411918032.X, filed December 24, 2024, in China, the disclosure of which is incorporated in its entirety by reference.

### TECHNICAL FIELD

The present disclosure relates to a loudspeaker assembly, and more specifically, to a micro loudspeaker assembly.

### BACKGROUND

Micro loudspeakers have been widely used in a variety of compact electronic products, such as mobile phones, tablets, laptops, and wearable devices. Nowadays, while micro loudspeakers continue to develop in electronic devices, for electronic devices, low frequency extension, high frequency extension, low distortion, large amplitude, and high sensitivity performance are persistently being pursued in the micro loudspeakers. Specifically, this means: micro loudspeakers, especially for bass applications, should have extreme low-frequency extension; micro loudspeakers, when used in full-range applications, should have good high-frequency extension; micro loudspeakers should have low distortion; micro loudspeakers should be able to be driven to a large displacement to output better sound; and micro loudspeakers should have high sensitivity.

However, conventional micro loudspeakers often cannot meet the above requirements, especially as electronic devices continue to upgrade and iterate, and there is a strong demand for an upgrade in their output sound, particularly in low-frequency extension, and even a requirement to match desktop HIFI audio. Conventional ultra-thin loudspeakers often fail to output the expected sound and are criticized by users.

Therefore, there is a need for a loudspeaker assembly that can at least partially solve the above problems, while satisfying low-frequency extension, low distortion and high sensitivity, and ensuring a compact space design in loudspeaker assemblies, especially micro loudspeaker assemblies.

### SUMMARY OF THE INVENTION

The present disclosure is directed to overcoming at least some of the above-mentioned problems in the prior art.

According to one aspect of the present disclosure, there is provided a loudspeaker assembly comprising: a magnetic circuit unit comprising a top plate and defining a magnetic gap; a frame unit connected to the magnetic circuit unit; and a vibration unit connected to the frame unit and comprising an upper diaphragm, a voice coil, and a dome, the voice coil extending at least partially into the magnetic gap, wherein the dome comprises a dome main body and at least two crimped edge portions surrounding the dome main body, wherein the dome is affixed to a top side of the voice coil by means of the crimped edge portions, such that the top plate of the magnetic circuit unit is disposed in a middle of the voice coil in a height direction.

According to one or more embodiments of the present disclosure, the voice coil and the top plate are arranged mirror-symmetrically with reference to a same plane of symmetry, wherein the plane of symmetry is a center plane extending perpendicularly to the height direction through the top plate of the magnetic circuit unit.

According to one or more embodiments of the present disclosure, the dome is constructed integrally.

According to one or more embodiments of the present disclosure, the dome main body is constructed at least partially planar.

According to one or more embodiments of the present disclosure, the crimped edge portions are bonded to the voice coil.

According to one or more embodiments of the present disclosure, the crimped edge portions are constructed by bending 180° to form a two-layer fold.

According to one or more embodiments of the present disclosure, the crimped edge portions are arranged spaced from each other so as to form a recessed portion between adjacent crimped edge portions.

According to one or more embodiments of the present disclosure, the dome has at least two first crimped edge portions opposed to each other and at least two second crimped edge portions opposed to each other.

According to one or more embodiments of the present disclosure, the recessed portion forms a channel connecting a radial interior and a radial exterior of the voice coil.

According to one or more embodiments of the present disclosure, the loudspeaker assembly further comprises a wire assembly that is guided through the recessed portion.

According to one or more embodiments of the present disclosure, the upper diaphragm is annularly constructed and comprises a central opening, a surround ring encircling the central opening, and a planar transition section disposed between the central opening and the surround ring.

According to one or more embodiments of the present disclosure, the crimped edge portions of the dome are arranged under the planar transition section of the upper diaphragm.

According to one or more embodiments of the present disclosure, the dome main body of the dome protrudes upward with respect to the crimped edge portions in the height direction, thereby forming a step between the dome main body and the crimped edge portions embedded in the central opening of the upper diaphragm.

According to one or more embodiments of the present disclosure, the surround ring of the upper diaphragm is constructed concavely.

According to one or more embodiments of the present disclosure, the dome has a bottom shape of a chamfered rectangular or runway shape.

According to one or more embodiments of the present disclosure, the loudspeaker assembly is a micro loudspeaker assembly.

### BRIEF DESCRIPTION OF THE DRAWINGS

In order to more clearly illustrate the technical solutions of the embodiments of the present disclosure, the drawings of the embodiments will be briefly introduced below. Apparently, the drawings in the following description only relate to some embodiments of the present disclosure, rather than limiting the present disclosure.

FIG. 1 schematically illustrates a perspective view of a loudspeaker assembly according to the present disclosure;

FIG. 2 schematically illustrates an exploded view of a loudspeaker assembly according to an embodiment of the present disclosure;

FIG. 3 schematically illustrates a disassembled view of some components of the loudspeaker assembly shown in FIG. 2;

FIG. 4 schematically illustrates a perspective view of a dome according to the present disclosure;

FIG. 5 schematically illustrates an enlarged view of Region B in FIG. 4;

FIG. 6 schematically illustrates a partial cross-sectional view of a loudspeaker assembly according to an embodiment of the present disclosure, taken along a section line A-A shown in FIG. 1;

FIG. 7 schematically illustrates a partial perspective view of a vibration unit of the loudspeaker assembly according to an embodiment of the present disclosure, including a lower diaphragm, a voice coil, and a wire assembly;

FIG. 8 schematically illustrates a partial perspective view according to the present disclosure, including an upper diaphragm, a dome, a voice coil, and a wire assembly;

FIG. 9 schematically illustrates a partial perspective cross-sectional view of the vibration unit of the loudspeaker assembly shown in FIG. 8;

FIG. 10 schematically illustrates a disassembled view of some components of the loudspeaker assembly according to another embodiment of the present disclosure;

FIG. 11 schematically illustrates a partial perspective view of the loudspeaker assembly according to another embodiment of the present disclosure, including an upper diaphragm, a dome, a voice coil, and a wire assembly;

FIG. 12 schematically illustrates a partial perspective cross-sectional view of the loudspeaker assembly shown in FIG. 11;

FIG. 13 schematically illustrates a partial cross-sectional view of a loudspeaker assembly according to another embodiment of the present disclosure, taken along the section line A-A shown in FIG. 1; and

FIG. 14 illustrates a driving force conversion factor BL curve of a loudspeaker assembly according to an embodiment of the present disclosure and a loudspeaker assembly of a comparative example.

### DETAILED DESCRIPTION

Embodiments of the present disclosure will be described in detail below. Examples of the embodiments are shown in the accompanying drawings, where the same or similar reference numerals always indicate the same or similar elements or elements with the same or similar functions. The embodiments described below with reference to the accompanying drawings are illustrative, which are only used to explain the present disclosure, and cannot be construed as limitations to the present disclosure.

Unless otherwise defined, the technical terms or scientific terms used here should have the ordinary meanings understood by those of ordinary skill in the field of the present disclosure. In the description of the present disclosure, it should be understood that an orientation or positional relationship indicated by the terms "center," "longitudinal," "lateral," "upper," "lower," "front," "back," "left," "right," "vertical," "horizontal," "top," "bottom," "inner," "outer," etc. is an orientation or positional relationship shown based on the accompanying drawings, is only for the convenience of describing the present disclosure and simplifying the description, rather than indicating or implying that a device or element referred to must have a specific orientation or be constructed and operated in a specific orientation, and thus cannot be understood as a limitation to the present disclosure. In addition, the terms “first” and “second” are used for descriptive purposes only, and cannot be construed as indicating or implying relative importance.

In this document, the term “height direction” refers to the direction z parallel to the central axis of the loudspeaker assembly; the term “axial” or “axial direction” refers to the direction along the central axis of the loudspeaker; the term “radial” or “radial direction” refers to the direction generally perpendicular to the height direction, pointing towards or away from the central axis; the term “radial inward” or “radial inner” refers to a component, part, position, or orientation relatively close to the central axis; and the term “radial outward” or “radial outer” refers to a component, part, position, or orientation relatively far from the central axis. The terms “upper” and “lower” are relative to the height direction z. “Upper” refers to the part, portion, position, or orientation of the upper diaphragm in the vibration unit of the loudspeaker assembly that is relatively close to or toward the loudspeaker assembly in the height direction. “Lower” refers to the part, portion, position, or orientation of the magnetic circuit unit of the loudspeaker assembly that is relatively close to or toward the loudspeaker assembly in the axial direction.

This application provides a loudspeaker component comprising: a magnetic circuit unit comprising a top plate and defining a magnetic gap; a frame unit connected to the magnetic circuit unit; and a vibration unit connected to the frame unit and comprising an upper diaphragm, a voice coil, and a dome, the voice coil extending at least partially into the magnetic gap, wherein the dome comprises a dome main body and at least two crimped edge portions surrounding the dome main body, wherein the dome is affixed to a top side of the voice coil by means of the crimped edge portions, such that the top plate of the magnetic circuit unit is disposed in a middle of the voice coil in a height direction.

According to one or more embodiments of the present disclosure, the voice coil and the top plate are arranged mirror-symmetrically with reference to a same plane of symmetry, wherein the plane of symmetry is a center plane extending perpendicularly to the height direction through the top plate of the magnetic circuit unit.

The loudspeaker assembly according to the present disclosure uses a dome with crimped edge portions. The construction of crimped edge portions increases the thickness of the dome, thereby appropriately lowering the voice coil that is affixed to the crimped edge portions in the height direction, so that the middle of the voice coil is generally aligned with the top plate of the magnetic circuit unit in the height direction. When the voice coil is, at half the height, located exactly at half of the thickness direction of the top plate, the center plane extending perpendicularly to the height direction through the top plate forms a plane of symmetry. Both the voice coil and the top plate are mirror-symmetrical with respect to this plane of symmetry. The resulting loudspeaker assembly allows for adjustments such as increasing the voice coil height from 1.55mm to 1.6mm, increasing the effective space of the vibration system from approximately 0.65mm to 0.8mm, and raising the magnet. As a result, the effective amplitude can be increased from 0.5mm to 0.65mm, effectively boosting the low-frequency response by more than 2dB. At the same time, the more symmetrical and higher BLx also results in better distortion and sensitivity.

According to one or more embodiments of the present disclosure, the dome main body is constructed at least partially planar. The crimped edge portions are constructed by bending 180° to form a two-layer fold. The crimped edge portions are arranged spaced from each other so as to form a recessed portion between adjacent crimped edge portions. The recessed portion forms a channel connecting a radial interior and a radial exterior of the voice coil. The loudspeaker assembly further comprises a wire assembly that is guided through the recessed portion.

The dome constructed according to the present disclosure includes a plurality of crimped edge portions spaced from each other so as to form a recessed portion between adjacent crimped edge portions. The recessed portion forms a channel between the radial interior and radial exterior of the voice coil, thereby establishing an airflow channel in the magnetic circuit unit. Due to the presence of airflow channel, the airflow between the space inside a center hole of the magnet and the space radially outside the magnet is smoother. This results in more even internal pressure when the loudspeaker assembly is working, improving the audio quality and heat dissipation of the loudspeaker assembly. On the other hand, the recessed portion allows for the entry of wiring, thereby making full use of the internal space of the loudspeaker assembly and achieving a compact structural design.

According to one or more embodiments of the present disclosure, the upper diaphragm is annularly constructed and includes a central opening, a surround ring encircling the central opening, and a planar transition section disposed between the central opening and the surround ring. The crimped edge portions of the dome are arranged under the planar transition section of the upper diaphragm. The dome main body of the dome protrudes upward with respect to the crimped edge portions in the height direction, thereby forming a step between the dome main body and the crimped edge portions embedded in the central opening of the upper diaphragm.

The dome constructed according to the present disclosure has a step formed between the dome main body and the crimped edge portions, thereby arranging the dome shape in a space-saving manner between the upper diaphragm and the voice coil without significantly affecting sound quality of the loudspeaker. This further improves the compactness of the structure.

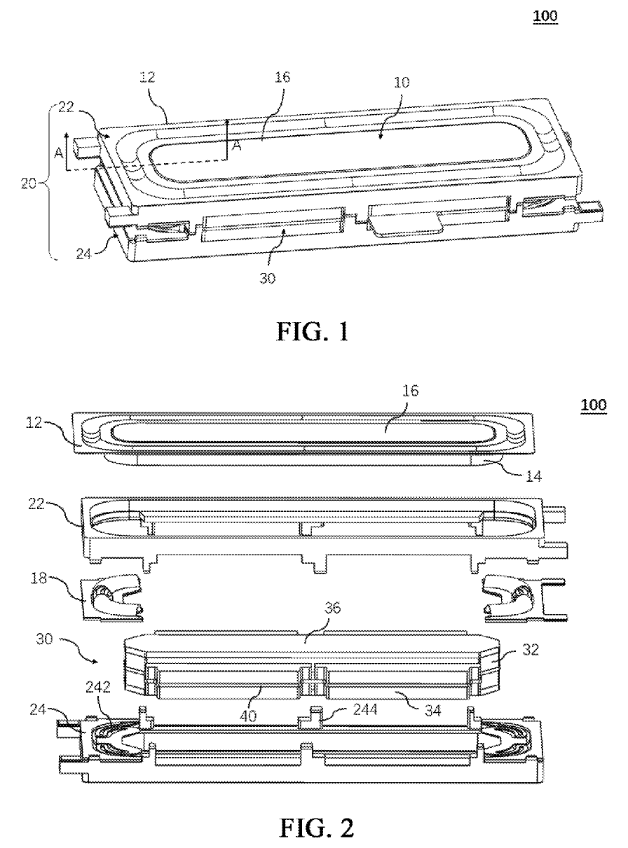

FIG. 1 schematically illustrates a perspective view of a loudspeaker assembly 100 according to the present disclosure; FIG. 2 schematically illustrates an exploded view of a loudspeaker assembly 100 according to an embodiment of the present disclosure.

The loudspeaker assembly 100 is generally rectangular in shape and includes a vibration unit 10, a frame unit 20, and a magnetic circuit unit 30.

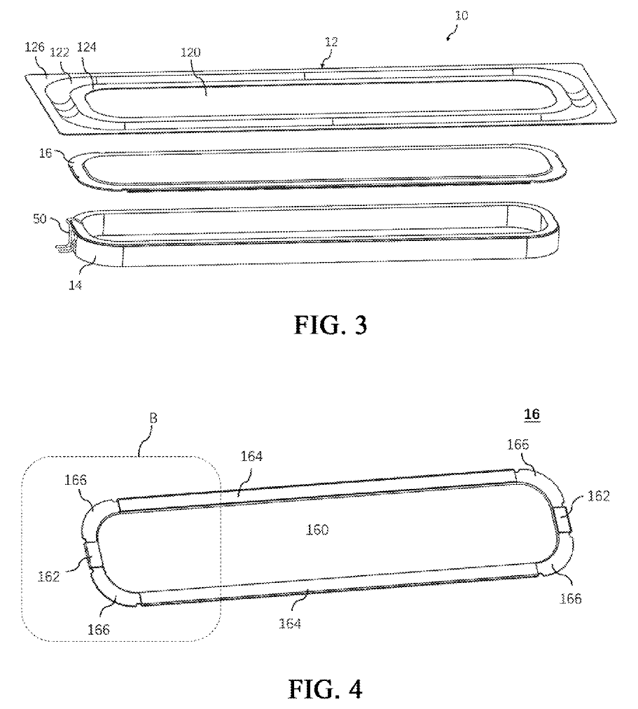

The vibration unit 10 includes an upper diaphragm 12, a voice coil 14, a dome 16, and an optional lower diaphragm 18. As shown in FIG. 3, the upper diaphragm 12 has a rectangular bottom shape, is generally annularly constructed, and has a central opening 120, a recessed surround ring 122 encircling the central opening 120, a planar transition section 124 arranged between the central opening 120 and the surround ring 122, and an outer section 126 radially outward encircling the surround ring 122. The outer section 126 is planar and flush with the planar transition section 124 in the height direction z (see FIG. 6). The voice coil 14 may include a bottom shape of a chamfered rectangular or runway shape. The top end of the voice coil 14 is connected to the upper diaphragm 12 via the dome 16, and the lower end of the voice coil 14 extends into a magnetic gap 38 (see FIG. 6) defined by the magnetic circuit unit 30.

As shown in FIG. 1, the frame unit 20 includes a first frame 22 and a second frame 24, wherein the first frame 22 and the second frame 24 are engaged with each other by means of slots and pins 244 on their respective circumferential surfaces.

The magnetic circuit unit 30 includes a central magnet 32, a side magnet 34 and a top plate 36, and defines the magnetic gap 38 (shown in FIG. 6).The top plate 36 and a yoke 40 of the magnetic circuit unit 30 act as magnetic conductors to guide and concentrate magnetic flux from the central magnet 32 and the side magnet 34, thereby passing it through the magnetic gap 38.

The loudspeaker assembly 100 also includes a flexible circuit board 242 disposed on the frame unit 20, and the flexible circuit board 242 is connected to the voice coil 14 by means of the wire assembly 50 (see FIG. 3) so as to transmit audio electrical signals to the voice coil 14.

In the embodiment shown in FIG. 6, the first frame 22 is arranged between the upper diaphragm 12 and the lower diaphragm 18, wherein the upper diaphragm 12 is affixed to the top side of the first frame 22 with its outer section 126. The magnetic circuit unit 30, together with its central magnet 32 and the side magnets 34 (not shown in detail), is centrally arranged in the frame unit 20. As previously described, the voice coil 14 is arranged between the magnet unit 30 and the first housing 22 and its lower end extends into the magnetic gap 38. The wire assembly 50 includes a first wire 52 and a second wire 54, wherein one end of the first wire 52 is connected to the flexible circuit board 242 located in a radial exterior of the voice coil 14, and the other end extends around the upper edge of the voice coil 14 to a radial interior of the voice coil 14.

When the loudspeaker assembly 100 is working, its vibration unit 10 vibrates up and down to produce sound. Due to the concave construction of the surround ring 122, the height of the voice coil 14 needs to be adjusted due to structural limitations. Therefore, according to the present disclosure, the dome 16, as shown in FIGS. 3 and 4, includes a generally planar dome main body 160 and a plurality of crimped edge portions arranged around the dome main body 160. In this embodiment, the dome 16 has a bottom shape of a chamfered rectangular. Two opposing first crimped edge portions 162 are provided on the short sides of the rectangle, and two opposing second crimped edge portions 164 are provided on the long sides of the rectangle. These crimped edge portions 162 and 164 are constructed by bending 180° to form a two-layer fold, thereby achieving a local increase in thickness. The dome 160 and the crimped edge portions 162 and 164 transition to each other through a step constructed by bending, wherein the dome 160 protrudes upward in the height direction z compared to the crimped edge portions 162 and 164, and is embedded in the central opening 120 provided by the upper diaphragm 12 in a shape fitting manner. The first crimped edge portion 162 and the second crimped edge portion 164 (not shown) are fixedly connected to the top side of the voice coil 14 by adhesive bonding, thereby appropriately lowering the position of the voice coil 14 in the height direction z.

Due to the concave structure of the surround ring 122, a height of an annular washer 222 embedded in the frame unit is slightly lower than that of the voice coil 14, which results in poor symmetry of the driving force. Compared to the prior art, this design allows the voice coil 14 to descend along the height direction z overall. In particular, FIG. 6 shows a center plane E0 extending perpendicularly to the height direction z through the top plate 36, and both the top plate 36 and the voice coil 14 surrounding the top plate 36 are mirror-symmetrical with reference to the center plane E0. In other words, the center plane E0 becomes the common plane of symmetry for the voice coil 14 and the top plate 36. The sections of voice coil 14 located above and below the plane of symmetry have substantially the same length. The loudspeaker assembly according to the present disclosure has better performance in its driving force conversion factor BL. Furthermore, this design allows for an increased length of the voice coil 14 and a greater weight for the entire vibration unit 10, which is beneficial for low-frequency extension and results in favorable acoustic effects such as low distortion and high sensitivity.

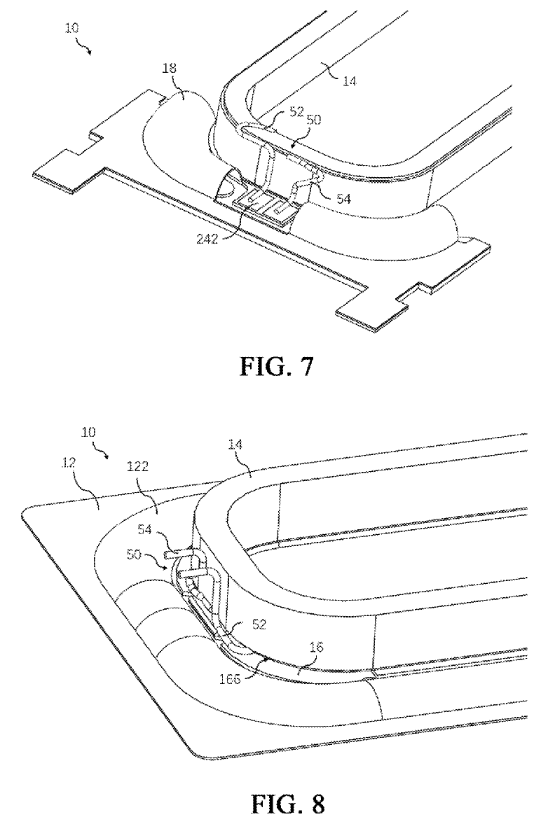

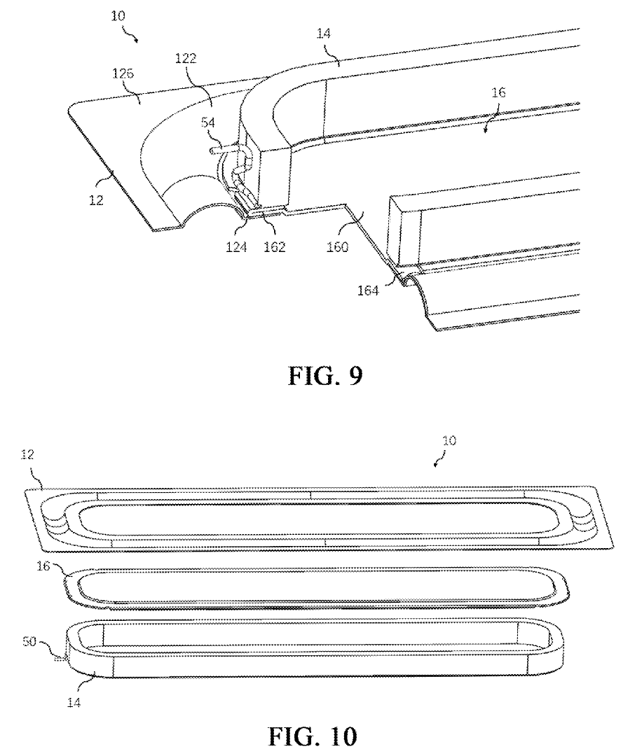

Furthermore, as mentioned above, a recessed portion 166 is formed between adjacent crimped edge portions, that is, in the non-double-folded area of the dome. For example, in this embodiment, the dome 16 includes four recessed portions 166 arranged before the first crimped edge portion 162 and the second crimped edge portion 164, and these recessed portions 166 are located at the four corners of the dome 16. Thus, a channel is formed at the top of the voice coil 14 through the recessed portion 166. For clarity, FIGS. 8 and 9 are rotated 180° compared to FIGS. 7 and 6, thus showing the location of the channel formed by the recessed portion 166. The first wire 52 in the wire assembly 50 extends from the radial exterior to the radial interior of the voice coil 14 through the recessed portion 166. In addition, the recessed portion 166 also functions as an airflow channel, connecting the internal space of the magnetic circuit unit 30, which is defined by the voice coil 14, with the external space of the voice coil 14. This helps ensure smooth airflow inside the loudspeaker assembly and achieves good heat dissipation.

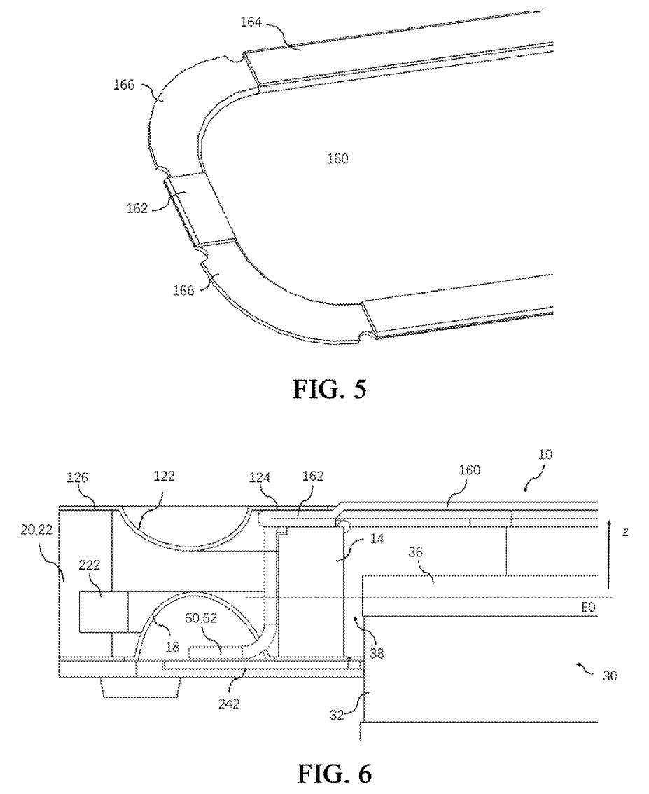

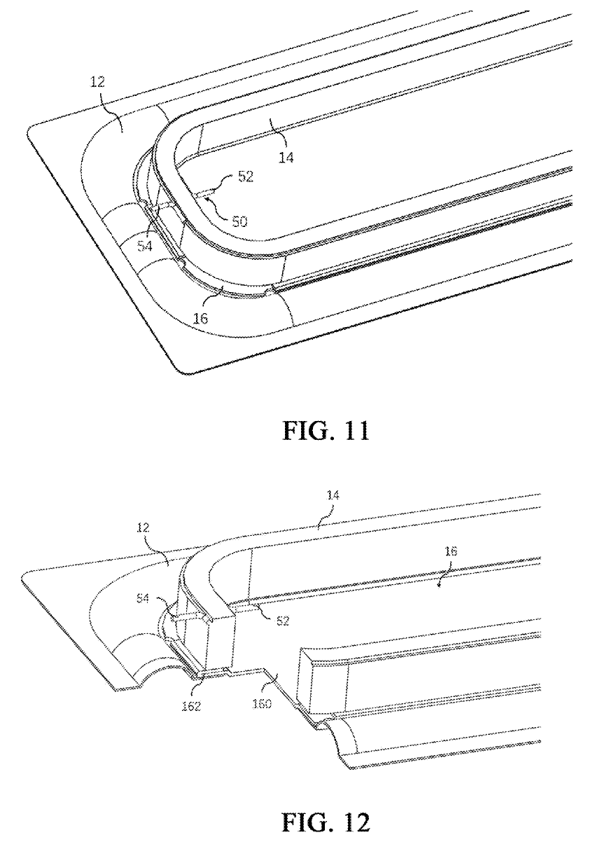

FIGS. 10 through 13 illustrate a loudspeaker assembly 100 according to another embodiment of the present disclosure. The main difference between this loudspeaker assembly 100 and the embodiments shown in FIGS. 2 to 9 lies in the construction of the wire assembly.

The loudspeaker assembly 100 is generally rectangular in shape and includes a vibration unit 10, a first frame 22, and a magnetic circuit unit 30.

The vibration unit 10 includes an upper diaphragm 12, a voice coil 14, a dome 16, and a lower diaphragm 18. The upper diaphragm 12 has a rectangular bottom shape, is generally annularly constructed, and has a central opening 120, a recessed surround ring 122 encircling the central opening 120, a planar transition section 124 arranged between the central opening 120 and the surround ring 122, and an outer section 126 radially outward encircling the surround ring 122. The voice coil 14 has a rectangular bottom shape with chamfered corners.

The magnetic circuit unit 30 includes a central magnet 32, a side magnet 34 and a top plate 36, and defines a magnetic gap 38. A top plate 36 and a yoke 40 of the magnetic circuit unit 30 act as magnetic conductors to guide and concentrate magnetic flux from the central magnet 32 and the side magnet 34, thereby passing it through the magnetic gap 38.

The loudspeaker assembly 100 also includes a flexible circuit board 242, and the flexible circuit board 242 is connected to the voice coil 14 by means of a wire assembly 50 so as to transmit audio electrical signals to the voice coil 14.

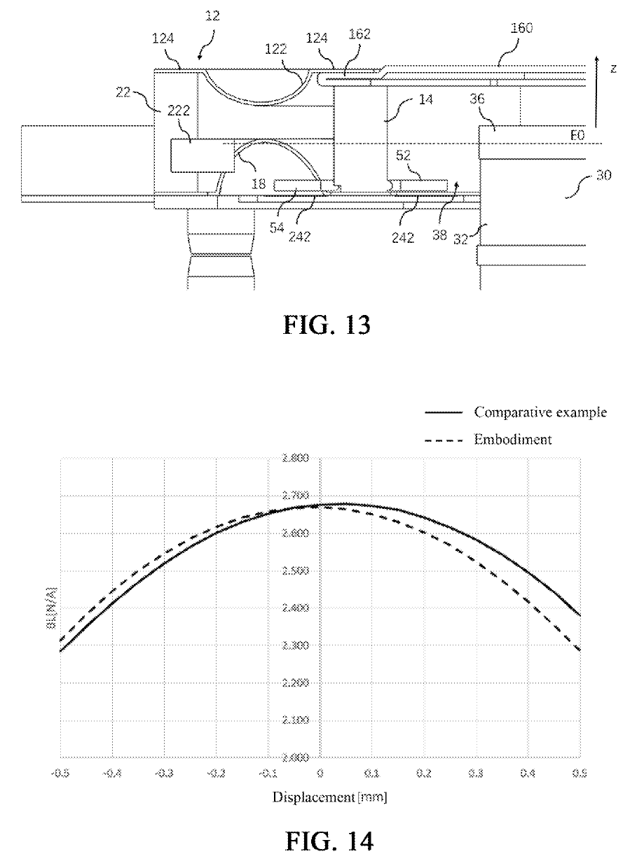

In particular as shown in FIG. 13, the first frame 22 is arranged between the upper diaphragm 12 and the lower diaphragm 18, wherein the upper diaphragm 12 is affixed to the top side of the first frame 22 with its outer section 126. The magnetic circuit unit 30, together with its central magnet 32 and the side magnets 34 (not shown in detail), is centrally arranged in the frame unit 20. The voice coil 14 is arranged between the magnet unit 30 and a first housing 22 and its lower end extends into the magnetic gap 38.

As shown in FIG. 12 and FIG. 13, the wire assembly 50 also includes a first wire 52 and a second wire 54, wherein the first wire 52 is arranged in a radial interior of the voice coil 14 and the second wire 54 is arranged in a radial exterior of the voice coil 14. The flexible circuit board 242 extends to the radial interior and radial exterior of the voice coil 14, so that neither the first wire 52 nor the second wire 54 needs to extend across the upper edge of the voice coil 14, but can directly contact the flexible circuit board 242 below the voice coil 14.

In such embodiment, it can not only achieve a simpler wiring method, but also allow for a larger pad area for each wire, resulting in a more stable and reliable connection.

The dome 16 has a rectangular bottom shape with chamfered corners. Two opposing first crimped edge portions 162 are provided on the short sides of the rectangle, and two opposing second crimped edge portions 164 are provided on the long sides of the rectangle. These crimped edge portions 162 and 164 are constructed by double-layering the material through 180° folding, thereby achieving a local increase in thickness. The dome 160 and the crimped edge portions 162 and 164 transition to each other through a step constructed by bending, wherein the dome 160 protrudes upward in the height direction z compared to the crimped edge portions 162 and 164, and is embedded in the central opening 120 provided by the upper diaphragm 12 in a shape fitting manner. The first crimped edge portion 162 and the second crimped edge portion 164 (not shown) are fixedly connected to the top side of the voice coil 14 by adhesive bonding, thereby appropriately lowering the position of the voice coil 14 in the height direction z.

As shown in FIG. 13, a center plane E0 extending perpendicularly to the height direction z through the top plate 36, and both the top plate 36 and the voice coil 14 surrounding the top plate 36 are mirror-symmetrical with reference to the center plane E0. In other words, the center plane E0 becomes the common plane of symmetry for the voice coil 14 and the top plate 36. The sections of voice coil 14 located above and below the plane of symmetry have substantially the same length.

When the loudspeaker assembly 100 is working, its vibration unit 10 vibrates up and down to produce sound. Due to the symmetrical design of the voice coil 14 in the height direction relative to the top plate 36, the loudspeaker assembly exhibits better performance in its driving force conversion factor BL. Furthermore, this design allows for an increased length of the voice coil 14 and a greater weight for the entire vibration unit 10, which is beneficial for low-frequency extension and results in favorable acoustic effects such as low distortion and high sensitivity.

FIG. 14 illustrates a driving force conversion factor (BL) curve of a loudspeaker assembly according to an embodiment of the present disclosure and a loudspeaker assembly of a comparative example. Compared to the comparative BL curve, the BL curve of the loudspeaker assembly according to the embodiments of the present disclosure is smoother and more symmetrical. Therefore, the loudspeaker assembly according to the embodiments of the present disclosure has lower total harmonic distortion and lower resonant frequency, resulting in better audio performance.

The present disclosure may be implemented in the following manners:

Item 1: A loudspeaker assembly comprising:

a magnetic circuit unit comprising a top plate and defining a magnetic gap;

a frame unit connected to the magnetic circuit unit; and

a vibration unit connected to the frame unit and comprising an upper diaphragm, a voice coil, and a dome, the voice coil extending at least partially into the magnetic gap,

wherein the dome comprises a dome main body and at least two crimped edge portions surrounding the dome main body, wherein the dome is affixed to a top side of the voice coil by means of the crimped edge portions, such that the top plate of the magnetic circuit unit is disposed in a middle of the voice coil in a height direction.

Item 2: The loudspeaker assembly according to Item 1, the voice coil and the top plate are arranged mirror-symmetrically with reference to a same plane of symmetry, wherein the plane of symmetry is a center plane extending perpendicularly to the height direction through the top plate of the magnetic circuit unit.

Item 3: The loudspeaker assembly according to Item 1 or 2, the dome is constructed integrally.

Item 4: The loudspeaker assembly according to any one of Items 1 to 3, the dome main body is constructed at least partially planar.

Item 5: The loudspeaker assembly according to any one of Items 1 to 4, the crimped edge portions are bonded to the voice coil.

Item 6: The loudspeaker assembly according to any one of Items 1 to 5, the crimped edge portions are constructed by bending 180° to form a two-layer fold.

Item 7: The loudspeaker assembly according to any one of Items 1 to 6, the crimped edge portions are arranged spaced from each other so as to form a recessed portion between adjacent crimped edge portions.

Item 8: The loudspeaker assembly according to any one of Items 1 to 7, the dome has at least two first crimped edge portions opposed to each other and at least two second crimped edge portions opposed to each other.

Item 9: The loudspeaker assembly according to any one of Items 1 to 8, the recessed portion forms a channel connecting a radial interior and a radial exterior of the voice coil.

Item 10: The loudspeaker assembly according to any one of Items 1 to 9, the loudspeaker assembly further comprises a wire assembly that is guided through the recessed portion.

Item 11: The loudspeaker assembly according to any one of Items 1 to 10, the upper diaphragm is annularly constructed and comprises a central opening, a surround ring encircling the central opening, and a planar transition section disposed between the central opening and the surround ring.

Item 12: The loudspeaker assembly according to any one of Items 1 to 11, the crimped edge portions of the dome are arranged under the planar transition section of the upper diaphragm.

Item 13: The loudspeaker assembly according to any one of Items 1 to 12, the dome main body of the dome protrudes upward with respect to the crimped edge portions in the height direction, thereby forming a step between the dome main body and the crimped edge portions embedded in the central opening of the upper diaphragm.

Item 14: The loudspeaker assembly according to any one of Items 1 to 13, the surround ring of the upper diaphragm is constructed concavely.

Item 15: The loudspeaker assembly according to any one of Items 1 to 14, the dome has a bottom shape of a chamfered rectangular or runway shape.

Item 16: The loudspeaker assembly according to any one of Items 1 to 15, the loudspeaker assembly is a micro loudspeaker assembly.

The foregoing is a description of the present disclosure and should not be considered a limitation thereof. Although several exemplary embodiments of the present disclosure are described, it will be readily understood by those skilled in the art that many modifications can be made to the exemplary embodiments without departing from the novel teachings and advantages of the present disclosure. Accordingly, all such modifications are intended to be encompassed within the scope of the present disclosure as defined by the claims. It should be understood that the foregoing is a description of the present disclosure and should not be considered to be limited to the particular embodiments as disclosed, and that modifications to the disclosed embodiments, as well as other embodiments, are intended to be included within the scope of the present disclosure.

1. A loudspeaker assembly, comprising:
a magnetic circuit unit comprising a top plate and defining a magnetic gap;
a frame unit connected to the magnetic circuit unit; and
a vibration unit connected to the frame unit and having an upper diaphragm, a voice coil, and a dome, the voice coil extending at least partially into the magnetic gap, wherein the dome has a dome main body and at least two crimped edge portions surrounding the dome main body, wherein the dome is affixed to a top side of the voice coil by means of the crimped edge portions, such that the top plate of the magnetic circuit unit is disposed in a middle of the voice coil in a height direction (z).

2. The loudspeaker assembly as claimed in claim 1, wherein the voice coil and the top plate are arranged mirror-symmetrically with reference to a same plane of symmetry, and the plane of symmetry is a center plane (E0) extending perpendicularly to the height direction (z) through the top plate of the magnetic circuit unit.

3. The loudspeaker assembly as claimed in claim 1, wherein the dome is constructed integrally.

4. The loudspeaker assembly as claimed in claim 1, wherein the dome main body is constructed at least partially planar.

5. The loudspeaker assembly as claimed in claim 1, wherein the crimped edge portions are bonded to the voice coil.

6. The loudspeaker assembly as claimed in claim 1, wherein the crimped edge portions are constructed by bending 180° to form a two-layer fold.

7. The loudspeaker assembly as claimed in claim 1, wherein the crimped edge portions are arranged spaced from each other so as to form a recessed portion between adjacent crimped edge portions.

8. The loudspeaker assembly as claimed in claim 7, wherein the dome has at least two first crimped edge portions opposed to each other and at least two second crimped edge portions opposed to each other.

9. The loudspeaker assembly as claimed in claim 7, wherein the recessed portion forms a channel connecting a radial interior and a radial exterior of the voice coil.

10. The loudspeaker assembly as claimed in claim 7, characterized in that the loudspeaker assembly further comprises a wire assembly that is guided through the recessed portion.

11. The loudspeaker assembly as claimed in claim 1, wherein the upper diaphragm is annularly constructed and comprises a central opening, a surround ring encircling the central opening, and a planar transition section disposed between the central opening and the surround ring.

12. The loudspeaker assembly as claimed in claim 11, wherein the crimped edge portions of the dome are arranged under the planar transition section of the upper diaphragm.

13. The loudspeaker assembly as claimed in claim 12, wherein the dome main body of the dome protrudes upward with respect to the crimped edge portions in the height direction (z), thereby forming a step between the dome main body and the crimped edge portions embedded in the central opening of the upper diaphragm.

14. The loudspeaker assembly as claimed in claim 11, wherein the surround ring of the upper diaphragm is constructed concavely.

15. The loudspeaker assembly as claimed in claim 1, wherein the dome has a bottom shape of a chamfered rectangular or runway shape.

16. The loudspeaker assembly as claimed in claim 1, characterized in that the loudspeaker assembly is a micro loudspeaker assembly.
